(19) United States
(12) Patent Application Publication
(10) Pub. No.: US 2017/0171329 A1
(43) Pub. Date: Jun. 15, 2017

(54) VIDEO RECOMMENDATON METHOD AND SYSTEM, AND SERVER

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Yin LI, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/240,491

(22) Filed: Aug. 18, 2016

Related U.S. Application Data
(63) Continuation of application No. PCT/CN2016/089521, filed on Jul. 10, 2016.

(30) Foreign Application Priority Data
Dec. 10, 2015 (CN) 2015109086106

(51) Int. Cl. H04L 29/08; H04L 29/06

(52) U.S. Cl. CPC H04L 67/26; H04L 65/60; H04L 67/18; H04L 65/80

(57) ABSTRACT

Embodiments of the present disclosure relate to the field of communications technologies, and disclose a video recommendation method and system, and a server. The method includes: acquiring video data that is being played by a user within a preset geographic location range; acquiring a video identifier of the video data; and determining, according to the video identifier, whether to recommend at least one piece of video data in the video data within the preset geographic location range. The embodiments of the present disclosure can implement recommending a video to a user based on a geographic location. For example, a video that is viewed by a quantity of users in an office area is recommended to users in the office area, to improve smartness of video recommendation and also improve user experience.

### CROSS-REFERENCE TO RELATED APPLICATIONS

This application is a continuation of International Application No. PCT/CN2016/089521, with an international filing date of Jul. 10, 2016, which is based upon and claims priority to Chinese Patent Application No. 201510908610.6, filed on Dec. 10, 2015, the entire contents of all of which are incorporated herein by reference.

### TECHNICAL FIELD

Embodiments of the present disclosure relate to the field of communications technologies, and more particularly, to a video recommendation method, a video recommendation system, and a server.

### BACKGROUND

Video recommendation refers to that a server automatically recommends some hot videos to a user, to improve smartness and also increase video on demand quantity, such that more users would watch the video.

In the prior art, in video recommendation, videos are generally recommended to the user based on time, for example, according to the on demand quantity by day or hot spots within a period of time. For example, during the World Cup, videos about football match or wonderful goal moments are used as recommended videos and are recommended to the user (for example, displaying in a page of a video play application (APP)). Alternatively, for example, the videos having the highest hits yesterday is used as a recommended video of today according to history data, and is recommended to the user.

A disadvantage of the existing recommendation method is hysteresis because the method depends on time, and therefore recommending a video according to time already cannot meet a requirement of the user on acquiring real-time information. For example, users in an office area probably have a similar interest in videos, that is, it is probably that the users in the office area are also interested in viewing videos that are viewed by one of the users. However, in the prior art, there is no video recommendation method or system based on a user's geographic location.

### SUMMARY

With respect to the technical problem that no solution to recommending a video to a user based on a user geographic location in the prior art, an embodiment of the present disclosure provides a video recommendation method. The method includes: acquiring video data that is being played by a user within a preset geographic location range; acquiring a video identifier of the video data; and determining, according to the video identifier, whether to recommend at least one piece of video data in the video data within the preset geographic location range.

According to an embodiment of the present disclosure, there is provided with a non-transitory computer-readable storage medium storing executable instructions that, when executed by an electronic apparatus, cause the electronic apparatus to perform an above disclosed method.

According to an embodiment of the present disclosure, there is provided with an electronic apparatus. The electronic apparatus includes: at least one processor; and a memory communicably connected with the at least one processor for storing instructions executable by the at least one processor, wherein execution of the instructions by the at least one processor causes the at least one processor to perform an above disclosed method.

### BRIEF DESCRIPTION OF THE DRAWINGS

The accompanying drawings are used to provide a further understanding of the present disclosure, and constitute a part of the specification, which are used to explain the present disclosure in combination with the specific embodiments of the present disclosure, and do not constitute a limitation to the present disclosure. In the accompanying drawings:

FIG. 1 is a schematic structural diagram illustrating a video recommendation system according to an embodiment of the present disclosure;

FIG. 2 is a schematic structural diagram illustrating a server according to an embodiment of the present disclosure;

FIG. 3 is an exemplary flowchart illustrating a video recommendation system according to an embodiment of the present disclosure; and,

FIG. 4 is a schematic hardware diagram of an electronic apparatus for a video recommendation system according to an embodiment of the present disclosure.

### DETAILED DESCRIPTION

The specific embodiments of the present disclosure are described hereinafter in detail with reference to the accompanying drawings. It should be understood that the specific embodiments described herein are merely used to describe and explain the present disclosure, and are not intended to limit the present disclosure.

A concept of the present disclosure is described below by using examples, but it should be understood that these examples are non-limiting examples, and the protection scope of the present disclosure is not limited thereto.

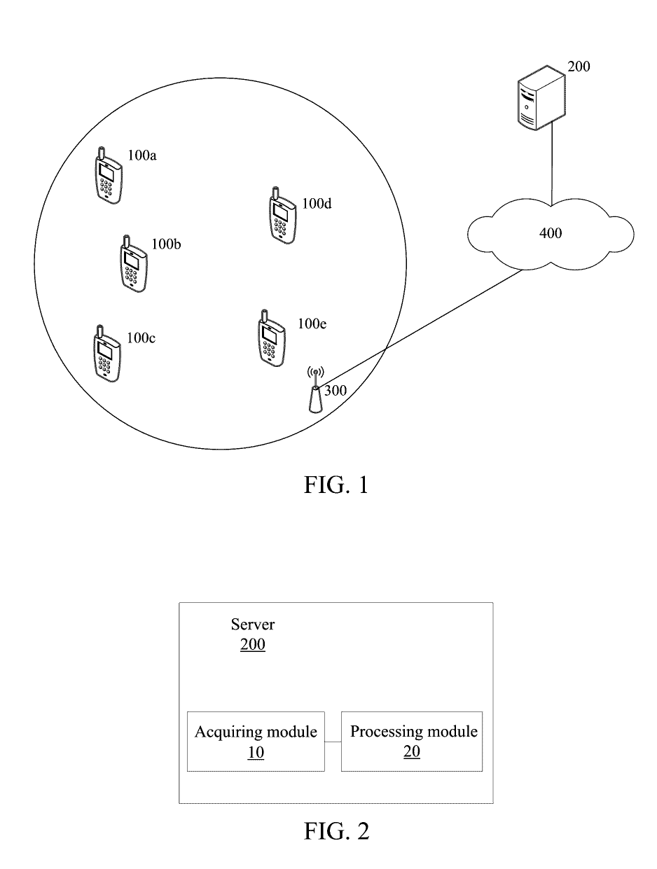

To more clearly describe the concept of the present disclosure, a video recommendation system is used as an example for detailed description. FIG. 1 is a schematic structural diagram illustrating a video recommendation system according to an embodiment of the present disclosure. As shown in FIG. 1, the system may include: client devices 100a, 100b, 100c, 100d, and 100e, and a server 200, where the client devices 100a, 100b, 100c, 100d, and 100e and the server 200 perform communication and data interaction via a wireless site 300 and an Internet 400. Although FIG. 1 shows the client devices in mobile phone form, it should be understood that the client devices 100a, 100b, 100c, 100d, and 100e may be devices that can communicate with the server, such as a mobile phone, a computer, and a tablet computer, and a quantity of the client devices is not limited to the quantity illustrated in FIG. 1, which is shown merely as an example, is not used to limit the present disclosure. The wireless site 300 is a radio access point and/or a base station.

According to an implementation manner of the present disclosure, the client devices 100a, 100b, 100c, 100d, and 100e may be video data played by a user within a preset geographic location range. For example, the client devices 100a, 100b, 100c, 100d, and 100e correspond to users a, b, c, d, and e, they may send, via a wireless network, the video data that is being played and a video identifier of the video data (for example, the video identifier may be a name of the video or a set of data code corresponding to the video data) to the server 200. The preset geographic location range is a circular area shown in FIG. 1, and the multiple client devices 100a, 100b, 100c, 100d, and 100e are all within a range of the circular area. The server 200 may be preset the preset geographic location range according to an actual situation. For example, a circular area centered at an office building or a landmark building with one kilometer in radius is set as the preset geographic location range, or another reference set except the circular area, for example, an ellipse, is the preset geographic location range, which is not limited in this embodiment of the present disclosure. With the technical solution, video data that is being played by a user within a preset geographic location range and an identifier are acquired, providing a data basis for a server to recommend a video to a user based on a geographic location.

FIG. 2 is a schematic structural diagram illustrating a server according to an embodiment of the present disclosure. As shown in FIG. 2, at a server side, the server 200 may include: an acquiring module 10, configured to acquire video data that is being played by a user within a preset geographic location range and a video identifier of the video data; and a processing module 20, configured to determine, according to the video identifier, whether to recommend at least one piece of video data in the video data within the preset geographic location range. In this implementation manner, recommending a video to a user based on a geographic location can be implemented. For example, a video that is viewed by a quantity of users in an office area is recommended to users in the office area, to improve intelligence of video recommendation and also improve user experience.

Specifically, to determine whether the user is located in the preset geographic location range, the acquiring module 10 may acquire data of a geographic location in which the user is located via the wireless network, that is, receive data of each geographic location (for example, GPS data) from the multiple client devices 100a, 100b, 100c, 100d, and 100e. Then the processing module 20 may determine, according to the data of the geographic location in which the user is located, whether the user is located in the preset geographic location range, that is, determine the data of the geographic location is within the specified preset geographic location range (for example, the circular area shown in FIG. 1).

After determining that the user is located in the preset geographic location range, the processing module 20 determines, according to the video identifier, whether to recommend at least one piece of video data in the video data within the preset geographic location range. In an example, the processing module 20 may add up a quantity of the video data that is being played by the user and that has the same video identifier; and when an adding-up result is greater than a recommended threshold, determine that at least one piece of video data corresponding to the adding-up result is used as a recommended video within the preset geographic location range.

For example, if a video A is being played by the client devices 100a, 100b, and 100c, a video B is being played by the client device 100d, and a video C is being played by the client device 100e, an adding-up result of a quantity of the video As is 3, and both adding-up results of the video B and C are 1 within the preset geographic location range. Assume that the recommended threshold is 2, the processing module may determine the video A is the recommended video. Alternatively, if the video A is being played by the client devices 100a, 100b, and 100c, the video B is being played by the client device 100d, and the video B is being played by the client device 100e, so that the adding-up result of the quantity of the video As is 3, and the adding-up results of the video B is 2 within the preset geographic location range. Assume that the recommended threshold is 2, the processing module may determine the video A and the video B are the recommended videos. That is, a quantity of the recommended videos is one or more videos that exceed a recommended threshold and that are being played within the preset geographic location range, and the recommended threshold may be preset or selected according to an actual situation, which is not limited in this embodiment of the present disclosure.

In an example, the server 200 may further include a pushing module, and the pushing module may push the recommended video to at least one user within the preset geographic location range. For example, refer to the foregoing example. If it is determined that the video A is the recommended video, the pushing module of the server may push the video A to at least one of the multiple client devices 100a, 100b, 100c, 100d, and 100e, preferentially, to the client devices 100d and 100e (because the multiple client devices 100a, 100b, and 100c may be identified as the devices that already view the recommended video A, the pushing module may select not to push). In addition, the server 200 may also push the recommended video to another client device except the client devices 100a, 100b, 100c, 100d, and 100e (not shown) within the preset geographic location range, such as a client device that just falls within the range.

Further, the server may further include a request sending module and a pushing module, where the request sending module is configured to send a request of pushing the recommended video to at least one user within the preset geographic location range, and the pushing module is configured to: when the at least one user responds to the request, push the recommended video to the at least one user.

For example, refer to the foregoing example. If it is determined that the video A is the recommended video, the request sending module of the server may first send the request of pushing the recommended video to at least one user of the multiple client devices 100a, 100b, 100c, 100d, and 100e, and sends the request to the client devices 100d and 100e (because the multiple client devices 100a, 100b, and 100c may be identified as the devices that already view the recommended video A, the request sending module may select not to send the request any more). In this case, at a client device side, for example, the client devices 100d and 100e may receive the request, and if the client device 100d or 100e responds to the request, the pushing module pushes the recommended video to the client device 100d or 100e, or if both the client devices 100d and 100e respond to the request, the pushing module pushes the recommended video to the client devices 100d and 100e. In addition, if another client device responds to the request except the client devices 100a, 100b, 100c, 100d, and 100e (not shown) within the preset geographic location range, the pushing module may also push the recommended video to the client device responding to the request.

It should be understood that, according to the server and the video recommendation method according to this embodiment of the present disclosure, video recommendation may be provided for any quantity of client devices (users) within a preset geographic location range, video recommendation may be simultaneously provided for any quantity of the client devices (users) in multiple different preset geographic location ranges, and the quantity of the client devices shown in this embodiment of the present disclosure are merely an example, which is not limited in the present disclosure.

In this embodiment, a video may be recommended to a user based on a geographic location. For example, a video that is viewed by a quantity of users in an office area is recommended to users in the office area, to improve intelligence of video recommendation and also improve user experience.

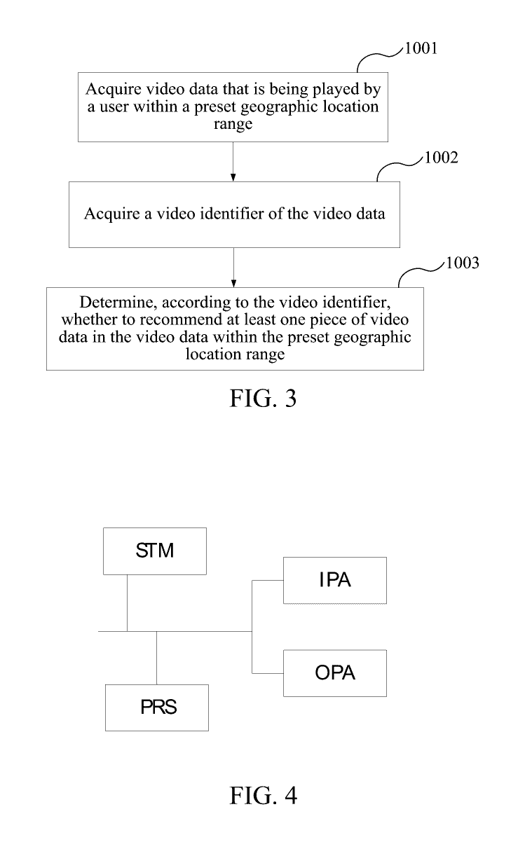

FIG. 3 is an exemplary flowchart illustrating a video recommendation system according to an embodiment of the present disclosure. As shown in FIG. 3, the method may include the following steps:

Step 1001: Acquire video data that is being played by a user within a preset geographic location range.

Step 1002: Acquire a video identifier of the video data.

Step 1003: Determine, according to the video identifier, whether to recommend at least one piece of video data in the video data within the preset geographic location range.

With the video recommendation method according to this embodiment of the present disclosure, video data that is being played by a user within a preset geographic location range and a video identifier of the video data are acquired; and it is determined, according to the video identifier, whether to recommend at least one piece of video data in the video data within the preset geographic location range, which can implement recommending a video to a user based on a geographically location. For example, a video that is viewed by a quantity of users in an office area is recommended to users in the office area, to improve intelligence of video recommendation and also improve user experience.

In an example, the determining whether to recommend at least one piece of video data in the video data within the preset geographic location range includes: adding up the quantity of the video data that is being played by the user and that has the same video identifier; and when an adding-up result is greater than a recommended threshold, determining to use at least one piece of video data corresponding to the adding-up result as a recommended video within the preset geographic location range.

In an example, the acquiring video data that is being played by a user within a preset geographic location range includes: acquiring data of a geographic location in which the user is located; and determining, according to the data of the geographic location in which the user is located, whether the user is located in the preset geographic location range.

In an example, the method further includes: pushing the recommended video to at least one user within the preset geographic location range.

In an example, the method further includes: sending a request of pushing the recommended video to at least one user within the preset geographic location range; and when the at least one user responds to the request, pushing the recommended video to the at least one user.

It should be understood that, each implementation manner of the video recommendation method is already described in detail in the exemplary implementation manners of the video recommendation system (as described above), and details are not described herein again. In addition, a person skilled in the art may select any one of the implementation manners according to the embodiments of the present disclosure, or any combination of the implementation manners to configure a client device and/or a server, and another alternative implementation manner also falls within the protection scope of the present disclosure.

With the video recommendation method and system, and the server according to the embodiments of the present disclosure, recommending a video to a user based on a geographic location can be implemented. For example, a video that is viewed by a quantity of users in an office area is recommended to users in the office area, to improve intelligence of video recommendation and also improve user experience.

According to an embodiment of the present disclosure, there is provided with a non-transitory computer-readable storage medium storing executable instructions that, when executed by an electronic apparatus, cause the electronic apparatus to perform any one of above disclosed methods.

FIG. 4 illustrates a schematic hardware diagram of an electronic apparatus for performing any one of above disclosed methods. According to FIG. 4, the electronic apparatus includes one or more processors PRS and a storage medium STM. FIG. 4 shows one processor PRS as an example.

The electronic apparatus can further include an input apparatus IPA and an output apparatus OPA.

The one or more processors PRS, storage medium STM and output apparatus OPA may be connected by a bus or other means. FIG. 4 shows a bus as an example for connection.

Storage medium STM is a non-transitory computer-readable medium for storing a non-transitory software program, a non-transitory computer-readable program and module, for example the program instructions/module for performing an above described method (e.g. acquiring module 10 and processing module 20 shown in FIG. 2). The processor PRS can operate the various functions and data processing of a server to perform a method described in the above embodiments by executing non-transitory software programs, instructions and modules stored in the storage medium STM.

The storage medium STM can include a program storage area and a data storage area. Among them, the program storage area may store operation system, application programs of at least one function; the data storage area may store generated data during operation of the electronic apparatus for performing the method described in the above embodiments. In addition, the storage medium STM may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium STM may include a storage medium that is remote to the processor PRS. The remote storage medium may be connected to the electronic apparatus for performing any of the above methods by a network. The examples of such as network include but not limited to Internet, enterprise intranet, local area network, mobile telecommunication network and a combination thereof.

The input apparatus IPA can receive input number or byte information, and can generate input key information relating to user setting and functional control of the electronic apparatus for performing the method described in the above embodiments. The output apparatus OPA may include a display device such as a display screen.

The one or more modules stored in the storage medium STM that, when executed by the one or more processors PRS, can perform any of the above described methods.

The above products can perform any of the above described methods, and have corresponding functional modules and effects. Details that are not disclosed in this embodiment can be understood by reference to the above method embodiments of the present disclosure.

An electronic apparatus of the present disclosure can exist in a varied form and includes but not limited to:
(1) A mobile communication device which is capable of performing mobile communication function and having a main purpose for audio or data communication. Such a mobile communication device includes: a smart phone (e.g. iPhone), a multimedia phone, a functional mobile phone and a low-end mobile phone etc.
(2) A super-mobile personal computer which belongs to the field of a personal computer and has calculation and processing functions, and in general can access to a mobile network. Such a terminal device includes: a PDA, a MID and a UMPC etc., for example iPad.
(3) A portable entertainment device which is capable of displaying and playing multimedia content. Such a device includes: an audio player, a video player (e.g. iPod), a handheld game console, an electronic book, a smart toy and a portable automotive navigation device.
(4) A server which can provide calculation service and can include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.
(5) Other electronic apparatus that is capable of data exchange.

The above described apparatus embodiments are for illustration purpose only, in which modules/units that are described above as separate elements may be physically separate or not separate and modules/units that are described above as display elements may be or may not be a physical unit, i.e. in a same location or in various distributed network units. The skilled person in this field can understand that it is possible to select some or all of the units or modules to achieve the purpose of the embodiment.

According to the above description, the skilled person in this field can understand that various embodiments can be implemented by software over a general hardware platform or by hardware. Accordingly, the above technical solution or what is contributed to the prior art may be implemented in the form of software product. The computer software product may be stored in a computer-readable storage medium, for example random access memory (RAM), read only memory (ROM), compact disk (CD), digital versatile disk (DVD) etc. which includes instructions for causing a computing device (e.g. a personal computer, a server or a network device etc.) to perform a method of some or all parts of any one of the above described embodiments.

Although preferable implementation manners of the present disclosure have been described in detail above with reference to the accompanying drawings, the present disclosure is not limited to specific details in the foregoing implementation manners. Various simple variations can be made to the technical solutions of the present disclosure within the scope of the technical idea of the present disclosure, and such simple variations all fall within the protection scope of the present disclosure.

It should be further noted that the specific technical features described in the foregoing specific embodiments can be combined in any appropriate manner as long as no conflict occurs. To avoid unnecessary redundancy, various possible combination manners will not be described in the present disclosure.

In addition, various different embodiments of the present disclosure may also be combined arbitrarily. Such combinations shall also be considered as the content disclosed by the embodiments of the present disclosure as long as these combinations do not depart from the concept of the present disclosure.

The previous description is provided to enable any person skilled in the art to practice the various embodiments of the present disclosure described herein but not to limit these aspects. Though the present disclosure is described by reference to the previous embodiments, various modifications and equivalent features will be readily apparent to those skilled in the art without departing from the spirit and scope of the present disclosure, and the generic principles defined herein may be applied to other aspects or with equivalent features. Thus, the claims are not intended to be limited to the aspects and features shown herein, but are to be accorded the full scope consistent with the language of the claims.

What is claimed is:

1. A video recommendation method, comprising:
acquiring video data being played by a user within a preset geographic location range;
acquiring a video identifier of the video data; and
determining, according to the video identifier, whether to recommend at least one piece of video data in the video data within the preset geographic location range.

2. The method according to claim 1, wherein the determining whether to recommend at least one piece of video data in the video data within the preset geographic location range comprises:
adding up a quantity of the video data being played by the user and having the same video identifier; and
when an adding-up result is greater than a recommended threshold, determining the at least one piece of video data corresponding to the adding-up result is used as a recommended video within the preset geographic location range.

3. The method according to claim 1, wherein the acquiring video data that is being played by a user within a preset geographic location range comprises:
acquiring geographic location data where the user is located; and
determining, according to the geographic location data where the user is located, whether the user is located in the preset geographic location range.

4. The method according to claim 1, further comprising:
pushing the recommended video to at least one user within the preset geographic location range.

5. A non-transitory computer-readable storage medium storing executable instructions that, when executed by an electronic apparatus, cause the electronic apparatus to:
acquire video data that is being played by a user within a preset geographic location range and a video identifier of the video data; and
determine, according to the video identifier, whether to recommend at least one piece of video data in the video data within the preset geographic location range.

6. The storage medium according to claim 5, wherein the storage medium further comprises instructions that cause the electronic device to:
add up a quantity of the video data that is being played by the user and that has the same video identifier; and
when an adding-up result is greater than a recommended threshold, determine that at least one piece of video data corresponding to the adding-up result is used as a recommended video within the preset geographic location range.

7. The storage medium according to claim 5, wherein the storage medium further comprises instructions that cause the electronic device to:
acquire data of a geographic location in which the user is located; and,
determine, according to the data of the geographic location in which the user is located, whether the user is located in the preset geographic location range.

8. The storage medium according to claim 5, wherein the storage medium further comprises instructions that cause the electronic device to push the recommended video to at least one user within the preset geographic location range.

9. The storage medium according to claim 5, wherein the storage medium further comprises instructions that cause the electronic device to:
send a request of pushing the recommended video to at least one user within the preset geographic location range; and,
when the at least one user responds to the request, push the recommended video to the at least one user.

10. An electronic apparatus, comprising:
at least one processor and a memory communicably connected with the at least one processor for storing instructions executable by the at least one processor;
wherein execution of the instructions by the at least one processor causes the at least one processor to:
acquire video data that is being played by a user within a preset geographic location range and a video identifier of the video data; and
determine, according to the video identifier, whether to recommend at least one piece of video data in the video data within the preset geographic location range.

11. The electronic apparatus according to claim 10, wherein the memory further comprises instructions that cause at least one processor to:
add up a quantity of the video data that is being played by the user and that has the same video identifier; and
when an adding-up result is greater than a recommended threshold, determine that at least one piece of video data corresponding to the adding-up result is used as a recommended video within the preset geographic location range.

12. The electronic apparatus according to claim 10, wherein the memory further comprises instructions that cause at least one processor to:
acquire data of a geographic location in which the user is located; and,
determine, according to the data of the geographic location in which the user is located, whether the user is located in the preset geographic location range.

13. The electronic apparatus according to claim 10, wherein the memory further comprises instructions that cause at least one processor to push the recommended video to at least one user within the preset geographic location range.

14. The electronic apparatus according to claim 10, wherein the memory further comprises instructions that cause at least one processor to:
send a request of pushing the recommended video to at least one user within the preset geographic location range; and,
when the at least one user responds to the request, push the recommended video to the at least one user.
